(19) United States
(12) Patent Application Publication
(10) Pub. No.: US 2009/0055269 A1
(43) Pub. Date: Feb. 26, 2009

(54) Methods and Systems for Preauthorizing Venue-Based Credit Accounts

(76) Inventor: Daniel Jonathan Baron, San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/196,005

(22) Filed: Aug. 21, 2008

Related U.S. Application Data
(60) Provisional application No. 60/957,099, filed on Aug. 21, 2007.

(51) Int. Cl. G06Q 30/00

(52) U.S. Cl. 705/14; 705/35

(57) ABSTRACT

A method and system for third party preauthorization of spending at a venue. The third party activates, on behalf of a user, a venue-based credit account for a spending transaction. The transaction is enabled only after at a user and/or a user-designee authorize the venue to open the venue-based credit account. The third party activates the venue-based credit account by providing a credit status of the user to the venue on behalf of the user and deactivates the venue-based credit account, by financially settling the transaction on behalf of the user, only after a triggering event.

### CROSS REFERENCE TO RELATED APPLICATION

This application is a nonprovisional of and claims the priority benefit of U.S. Provisional Application No. 60/957,099, filed Aug. 21, 2007, the content of which is hereby incorporated by reference into the present patent application in its entirety.

### FIELD OF THE INVENTION

The present invention relates to methods and systems for preauthorizing venue-based credit accounts for transactions, such as purchases of food or beverages, at a venue prior to initiating said transactions.

### BACKGROUND

The use of bar tabs and similar, venue-based credit accounts is widespread. Essentially, a bar tab is an open line of credit with an establishment, backed by some form of payment guarantee. Often, the guarantee comes in the form of a credit card that a patron leaves with the bartender, server or other person associated with the venue.

Food and/or beverages consumed/ordered by the patron are tallied on the tab while the patron is present at the venue. Prior to the patron leaving the establishment, the tab is totaled and payment is effected by charging the credit card for that total tab amount. Gratuities may also be included in the amount charged to the patron's credit card. Thereafter, the patron is typically asked to sign the credit card receipt (to indicate his/her agreement to pay these charges) and the credit card is returned to the patron at the end of this transaction.

There are several disadvantages associated with this customary use of bar tabs. For example, because the patron must part with his/her credit card, that card is subject to compromise. If a credit card associated with an open tab is kept in a visible location, persons other than the card holder may be able to copy down the account number and other identifying information present on the card and use same for improper/unauthorized purposes. More simply, the card may be lost or damaged while out of the patron's possession. Or, the patron may simply forget to collect his/her card before leaving the venue. This latter condition can lead to several problems for the establishment hosting the patron. For example, it may not be possible to secure payment settlement through a credit card company should the patron dispute the transaction at a later time and the bar is incapable of providing a signed customer receipt. Moreover, the establishment may be precluded from including a gratuity in the charged total if the patron has left the premises. At a minimum, bartenders and others are inconvenienced by having to open and close tabs and process the associated credit card transactions, all of which takes time away from serving patrons.

Another concern relating to the use of bar tabs is fraud. Establishments willing to extend credit to their patrons on a promise of payment in the form of a physical credit card take the risk that the card is in fact valid and associated with a credit limit sufficient to cover the patron's purchases. In some cases, stolen, invalid, or inoperative cards may be presented to open tabs which certain patrons have no intention of honoring. As a result, establishments and individual bartenders and servers may lose the entire amount of a tab. Accordingly, what is needed are improved methods and systems for processing credit-based transactions at bars and other establishments.

### SUMMARY OF THE INVENTION

The methods and systems of the present invention provide for a third party to preauthorize spending at a venue by provisioning, on behalf of a user, a venue-based credit account for a spending transaction. The spending transaction is enabled only after at least one of the user and a user-designee authorizes the venue to activate the provisioned venue-based credit account and the third party provides, on behalf of the user a credit status of the user to the venue. The venue-based credit account is deactivated only after a triggering event. To deactivate the venue-based credit account, the third party financially settles the transaction on behalf of the user.

In an embodiment, the third party is a business enterprise operating at a Web site and/or other equipment adapted to interact with the user, and to provision the venue-based credit account. The business enterprise may, for example, operate an Internet web site hosted by a server.

In an embodiment, to activate the venue-based credit account, a virtual ticket is created within a point of sale processing system associated with the venue.

In another embodiment, the triggering event may consist of the user and/or the venue deactivating the venue-based credit account. Alternatively, or in addition, the triggering event may consist of expiration of a period of time.

In a further embodiment, the third party receives a user-payment-guarantee means from the user. Moreover, the credit status of the user and the user payment guarantee means may be, but are not necessarily, identical.

In an embodiment the third party receives a request from the user to provision the venue-based credit account while the user is located at the venue. Alternatively the third party may receive a request from the user to provision the venue-based credit account while the user is located away from the venue.

In another embodiment, the third party receives a request from the user through an interactive response system interface. The interactive response system may be accessible to the user by telephone.

In a further embodiment, the third party receives a request from the user via the Internet web site.

The request of the user to provision a venue-based credit account may consist of at least one user preference and provisioning the venue-based credit account may include informing the venue of the at least one user preference. The user preference may be a gratuity, a method of calculating a gratuity amount and/or a acceptance of a gratuity policy set by the venue. Alternatively, or in addition, the user preference may include a payment guarantee means, which may consist of a cash prepayment, a bank account, a credit card account, a debit card account, and/or a web-based payment guarantee.

In an embodiment, a request of the user to provision a venue-based credit account may include at least one user reservation request and provisioning may be accomplished by informing the venue of the reservation request and receiving an indication from the venue when the reservation request is confirmed. The user reservation request may include identifying a specific table at the venue and/or a request for bottle service. Additionally, the user reservation request may include identifying at least one of a quantity, a type and a brand of a beverage.

In a further embodiment, the request of the user further may include identification of invitees, and the provisioning step comprises forwarding invitations to said invitees. Moreover, the user reservation request may be a contingent reservation request. The user reservation request may include identification of co-hosts and the provisioning step may include forwarding requests for contribution to each co-host. Moreover, the provisioning step may include receiving an acceptance and/or a declination of said request. The acceptance may include a co-host payment guarantee means.

In an embodiment, the credit status of the user provided to the venue comprises a credit guarantee. The credit guarantee may include a bank account, a credit card account, a debit card account, and/or a web-based payment guarantee. The credit status of the user may include a spending limit associated with the credit guarantee and/or exclude personal financial information of the user.

In an embodiment, the user and/or the user-designee authorize the venue to activate the provisioned venue-based credit account by presenting at least one of a password, the password having been provided by the third party to the user and to the venue, a bank card, and/or a biometric indicator. The biometric indicator may include at least one of a photo-ID and a signature.

In an embodiment, the venue is a restaurant, a bar, a night club, and/or a retail store.

In an embodiment, a request by the user to provision a venue-based credit account may include identifying the user-designee.

In a further embodiment, the business enterprise contracts with a number of venues and each venue undertakes to accept payment by way of a venue-based credit account.

In another embodiment, financially settling the transaction may include providing a payment processor with transaction clearing information, said transaction clearing information comprising financial information of the user and merchant account information of the venue.

In an embodiment, the third party receives an authorization to furnish the user with a virtual coupon; and furnishes the user with a virtual coupon. The authorization may be provided by a product manufacturer, a product distributor and/or a merchant.

### BRIEF DESCRIPTION OF THE DRAWINGS

The present invention is illustrated by way of example, and not limitation, in the figures of the accompanying drawings, in which:

FIG. 1 is a flow diagram illustrating a method for preauthorizing spending on an existing credit account for transactions, such as purchases of food or beverages, at designated venues prior to initiating said transactions, in accordance with an embodiment of the present invention; and

FIG. 2 illustrates an example of a system for preauthorizing spending on an existing credit account for transactions, such as purchases of food or beverages, at designated venues prior to initiating said transactions in accordance with an embodiment of the present invention.

### DETAILED DESCRIPTION

Described herein are methods and systems for preauthorizing spending, such as for purchases of food, beverages, or merchandise at a venue prior to engaging in such purchases. In one embodiment of the present invention, a preauthorized venue-based credit account is provisioned on behalf of a patron (or “user”) prior to the user's visiting the establishment (or “venue”) at which the transaction is to be conducted. Preferably, after the initial provisioning, the venue-based credit account may be accessed (as described below) at multiple venues for an indefinite period of time. Provisioning may be accomplished by providing at least one user preference such as a payment guarantee valid for an amount not exceeding a pre-set limit, where the payment guarantee is funded from, for example, a bank account or credit or debit card account, or a PayPal® account or similar web-based service. Spending limits and other preferences may be established at the time the venue-based credit account is provisioned. For example, predefined gratuity amounts may be established on a per-item or percentage of total order basis, or other basis. Thereafter, the patron (or another patron designated by the user, i.e., a user-designee) may activate his/her provisioned venue-based credit account upon arrival at the associated venue. This activation step enables a transaction, such as a purchase, to be charged to the venue-based credit account. Advantageously, the user need not provide the venue with the user's personal financial information such as the user's bank-issued credit card or credit card number. Instead, the user may activate the venue-based credit account—and enable a transaction—merely by providing a personal identifier such as a driver's license. The patron may close (deactivate) the account prior to or after leaving the venue, or the account may be automatically deactivated no later than a specified time, when the establishment ceases processing transactions for the day, or upon the occurrence of some other triggering event.

Embodiments of the present invention involve computer software and hardware, for example in the form of servers, point of sale terminals, personal computers, mobile computer-based devices, mobile phones, and the like. Such devices and software generally execute algorithms which implement methods that are embodiments of the present invention. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

The present invention can be implemented with apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

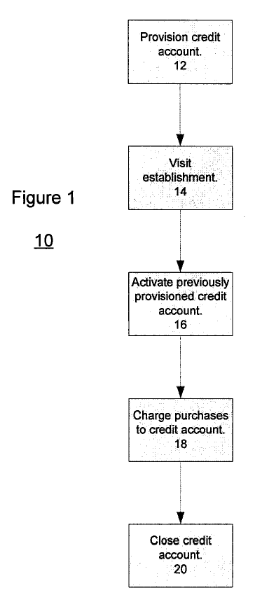

Referring now to FIG. 1, a flow diagram illustrates a method 10, which describes an embodiment of the present invention. At step 12, upon request of a user (who will become a patron at one or more establishments) the method provisions a venue-based credit account for use at establishments (venues) which have agreed to accept payment by way of such venue-based credit accounts. Usually, though not necessarily, the user's account will be provisioned once, and may be accessed thereafter by the user at any of a number of venues for an indefinite period. Such provisioning may occur long before the user/patron arrives at a particular establishment at which he or she intends to access the credit account. In some cases, on the other hand, a venue-based credit account may be provisioned just before a user intends to access it. For example, the user may request provisioning of an account upon arriving at a particular establishment, for example using a mobile computer device, personal digital assistant, mobile phone equipped with a Web browser, or other similar device. Alternatively, or in addition, the establishment itself may provide means (such as a computer terminal configured for Internet access) for the user/patron to request provisioning of a venue-based credit account. Such means may include, for example providing an electronic device through which a conventional credit card (e.g., a magnetic stripe bank card, integrated circuit (“smart”) card or any other type) may be swiped, together with means for identity verification (e.g., photo ID, signature or other biometric indicator).

In one embodiment of the invention, a user may request provisioning of a venue-based credit account through the use of an interactive response system. For example, instead of accessing a Web site using a browser, the user may instead access an interactive system by dialing a telephone number (e.g., using a mobile phone or land line). The interactive system may be accessed through, for example, the use of audio tones associated with touch pad key events and/or spoken responses to prompts and a user may thereby request provisioning of a venue based credit account. Such systems are commonly used for such things as filling existing medication prescriptions, reviewing airline reservations, and the like. In the context of the present invention, the system is adapted to allow the user to request provisioning of a venue-based credit account for each of one or more establishments for designated dates/times. The remaining discussion focuses on the use of the Web-based systems and related processes, however, it should be recognized that these systems and processes can be implemented using the dial-up interactive response system as well.

The venue-based credit account is preferably provisioned through a user accessing a Web site (i.e., a hosted application running at a server or other computer host accessible via one or more computer networks or networks of networks, such as the Internet) using a Web browser, though this may not necessarily be true in all cases. For example, in the case of personal digital assistants, mobile phones and the like which are not equipped with a Web browser or for which the user/patron prefers not to use the Web browser feature, the user may request provisioning an account using text messaging sequences or a client application resident on the device/mobile phone. Such a client application or applet may be specially configured to allow the user/patron to specify the information described below in order to provision the credit account. Using the host platform's connectivity capabilities (e.g., a wireless local area network connection, GPRS/GSM connection, or other communication facility), the client application can then provide the provisioning information to a remote computer resource (such as the server discussed below) in order to facilitate provisioning of the venue based credit account.

In general, the Web site will provide one or more forms for collection of user/patron data, as discussed below. This data is subsequently stored in one or more databases that may be co-located with the host at which the Web site application executes, or may be located on remote hosts communicatively coupled to the Web site host. The databases may be organized in any manner convenient to the storage of such information, and the precise nature of the hosts, databases and Web site/Web forms used to collect and store the user data is not critical to the present invention.

As indicated above, the user may request provisioning of a venue-based credit account by accessing a Web site. The Web site may be accessed using a user name/password combination as is common for user accounts associated with Internet Web sites. Other forms of access may also be used, such as a biometric indicator, speech recognition, etc., but the details of such processes are not critical to the present invention.

In the event the user does not have an existing user account with the service associated with the Web site, the user is prompted to create such a user account (which may include choosing a user name and password or other form of authentication information). The account details may include the user's name, address (and/or other contact information), age (optional), preferred form of user payment guarantee (e.g., a credit card or debit card account number and expiration date, or a bank account, such as a checking account, from which automated withdrawals are authorized), and government issued identification information (e.g., driver's license number). In some cases, the user payment guarantee means may be facilitated off-line, for example by the user paying cash into an escrow account from which the service associated with the Web site may make deductions. Other user payment guarantee means may also be used, for example PayPal™ accounts and similar Web-based payment systems may be used.

Other user preferences may also be associated with the user account. For example, preferences relating to the payment of gratuities may be specified. The user may configure his/her account such that gratuities are automatically added to each individual purchase (e.g., each individual drink order recorded on a tab processed in the manner discussed below) and/or to aggregate purchases (e.g., a total of a bar tab processed in the manner discussed below). Gratuity amounts may be determined on a flat fee, percentage of total order, percentage of total amount spent at a venue, combinations of flat fee and percentage-based payment amounts (e.g., based on itemized ordering), or other bases.

Assuming that the user has an existing user account, or once the user has created a user account with the service, the venue-based credit account for a particular establishment, or multiple venue-based credit accounts for any number of establishments, may be activated. For example, after having requested provisioning of the credit account, the user may then proceed to any participating establishment at some later time, step 14 (“participating establishment” as used herein, means a venue that has agreed to accept payment by way of a venue-based credit account). The venue-based credit account will provide the user with means to charge food and/or beverages (or, more generally, purchases) to a “tab”, without having to establish that tab with the establishment personnel. That is, the venue may confirm with the service operating the Web site that the user's active venue-based credit account was provisioned (as guaranteed by the user's designated payment means) at some point prior to the user's use of the venue-based credit account at the establishment. Upon arrival at the establishment, the user simply needs to identify him/herself to appropriate personnel (e.g., a bartender, host/hostess, or other person), indicate the existence of the venue-based credit account and (optionally) provide a password or other form of identification to activate the account, thereby enabling a transaction such as a purchase, step 16.

The password or other form of identification may be a unique password or other token provided by the Web site when the user requests provisioning of a credit account for the evening. One benefit of such a system for activating the credit account is that the user/patron that requested the account need not necessarily be the same person that uses the account. For example, this way parents can provision a credit account for children away at college and allow those children to enjoy an evening at a designated restaurant or other venue, without having to arrange for gift cards, or provide the children with cash or other payment means. The passwords may be unique alpha-numeric passwords generated in pseudo-random fashion by the Web site for each individual credit account, thus reducing the possibility that an unauthorized person can fraudulently activate a credit account at an establishment.

Alternatively, the venue-based credit account may be activated, and subsequent transactions enabled, by presenting some form of user/patron identification, such as a driver's license or credit card. The establishment may provide a designated station (such as a card swipe/magnetic stripe reader) for such purposes, or an existing station (e.g., associated with a point of sale terminal) may be used for such purposes. Of course, other forms of account activation means may be used. For example, a host/hostess may manually activate the venue-based credit account upon presentment of the user/patron's identification.

Once active, the user/patron may charge purchases (e.g., food and/or beverage purchases) to the credit account, step 18. Any of several means may be used to keep track of these purchases. For example, one embodiment of the present invention provides for the service associated with the Web site at which the user provisioned his/her account to transmit information regarding the user's credit status to the designated establishment. In some cases the information may be transmitted by facsimile message, e-mail or similar means, advising the establishment that the user/patron will be visiting the establishment and authorizing the creation of a tab for use by the patron (in accordance with the terms specified by the user/patron when the credit account was provisioned). The user's credit status information may include a credit guarantee, provided, for example, by way of the user's credit card, debit card, cash prepayment and/or a web-based payment guarantee.

Preferably, however, the existence of the credit account (and any conditions associated therewith) is provided to the establishment electronically. That is, the server at which the Web site is hosted, or another computer means associated therewith, transmits to the designated establishment for which the credit account is intended, the authorization for the creation of a tab. This may be done, in one embodiment, by creating a virtual ticket within the establishment's point of sale (POS) processing system, much in the same way a virtual ticket is created when a bartender opens a conventional tab based on a credit card from a bar patron. POS integration generally involves transmission of instructions in eXtensible Markup Language (XML) format over the Internet and may occur through a POS application programming interface (API). The XML format is customized to meet the needs and the specification of the POS system. This mechanism is similar to existing solutions for on-line ordering at restaurants, except that, instead of an actual order being placed, only a ticket is created in the POS system for later use when the patron activates the credit account by identifying him/herself and/or providing a password, as described above. Alternatively, the virtual ticket may be created only after the user activates the venue-based credit account.

The virtual ticket may be associated with the password or other user/patron identifying information so that it can be readily accessed by establishment personnel when needed. In some cases, the password required by the user may be the ticket identifier created by the establishment POS system. In such cases, at the time the credit account is provisioned, the service associated with the Web site will contact the establishment POS system, request that the virtual ticket be established, receive the ticket identifier in return and provide that identifier to the user/patron for later use, as discussed above. Alternatively, the user can create their own password which will then be communicated to the venue in the method described above.

As indicated, once the user has activated his/her credit account at the establishment, the user/patron (or user-designee) is enabled to charge purchases to that account. Prior to leaving the establishment, the user/patron may close (deactivate) the credit account, step 20, either by indicating same to the appropriate establishment personnel, by instruction issued via a text message, the Web site (e.g., via an application resident on a mobile phone or other device) or other means (e.g., a dedicated terminal within the establishment); in any of the foregoing methods of closing the account, the user may, in addition, change the previously specified preference with respect to gratuities. Or, the user/patron may simply leave the establishment and the credit account will be automatically deactivated in accordance with the instructions specified at the time the account was provisioned, in accordance with the user's previously specified preferences for same, when the establishment closes all transactions for the day, or when the user activates a venue-based credit account at a different venue. As a further example, the establishment POS system may signal the Web site associated with the credit account that the credit account is being deactivated or vice versa.

Payment for the credit account may be effected in any of several ways. For example, the service may provide the establishment with the user's payment guarantee information or other credit guarantee at the time the credit account is activated at the establishment. This may involve adding the user's credit or debit card account information (account number, expiration date, name, other identifying information, etc.) to the virtual ticket within the POS system. Or, the service itself, for example, as a payment processor or third party to the transaction, may financially settle the transaction without providing such information directly to the establishment. For example, the establishment POS system may present the account total to the Web site, the appropriate gratuities may be added (in accordance with the venue's requirements or the user's specified preferences or instructions) and the Web site may provide a payment processor with transaction clearing information, including, for example, financial information of the user and merchant account information of the vendor. Upon receiving acknowledgement from the payment processing center, the Web site may return payment settlement information to the establishment.

In some cases, the above transactions may be processed via a designated POS system associated with the credit account service. That is, the service may install designated equipment and/or software at venues to facilitate the types of transactions contemplated herein. This will relieve the individual establishments from having to upgrade legacy equipment in order to facilitate such transaction.

The service referred to herein is meant to indicate a business enterprise that operates the Web site and other equipment associated with the establishment, provisioning and transaction resolution for the credit accounts described herein. Such a service may be operated under the trade name “OpenMyTab Corporation” or other name. The service is preferably provided via one or more Web sites hosted at one or more servers or similar equipment as described herein.

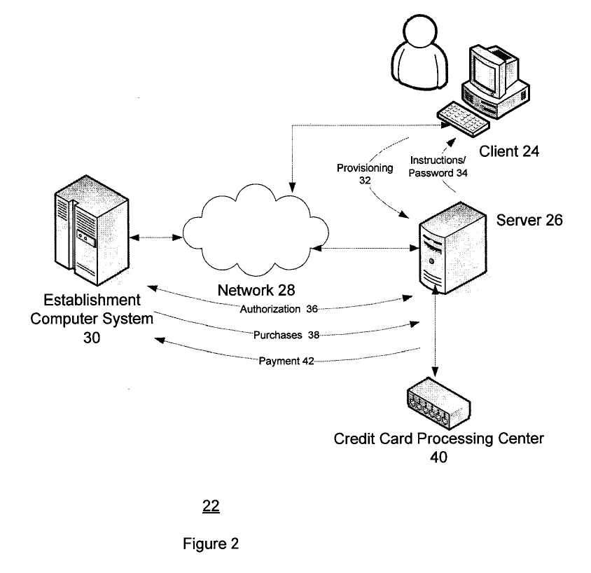

Referring now to FIG. 2, a basic architecture for processing the methods of the present invention is illustrated. System 22 includes one or more clients 24 communicatively coupled to one or more servers 26 via one or more computer networks 28, such as the Internet. The client may be any form of personal computer or mobile device, as discussed above. The server 26 acts as a host for the Web site and/or databases described above. In cases where the databases are hosted remotely from the Web site, additional servers (not shown in this illustration) would be communicatively coupled to server 26 (e.g., via network 28).

Also illustrated as part of system 22 is a computer resource 30 associated with an establishment. As indicated above, the computer resource 30 may represent an existing POS system used by the establishment, or a dedicated system configured for use in accordance with the present invention. In some cases, resource 30 may include the magnetic stripe/card reader to facilitate activation of a credit account and/or a facsimile or other receiving means to receive credit account authorization information. Instead of a facsimile machine, e-mail, short message service (SMS), instant messaging, calls placed to the interactive service described above (e.g., where the account can be activated by responding appropriately to menu prompts), or other communication means may be used to pass such information to the establishment. For simplicity, only the computer-to-computer communication means are illustrated in the Figure, but this is not intended to limit the present invention.

As indicated above, client 24 interacts with a Web site hosted at server 26 (via network 28) to provision a credit account for a particular establishment. Where appropriate, this may involve first creating a user account. As shown, the user/patron provides credit account information/instructions 32 to the Web site hosted at server 26 and in return the Web site may provide account activation information or instructions 34 back to the user. This may, in some cases, include a password or other information needed by the user to activate the credit account at the establishment.

Thereafter, or during the credit account provisioning process, the server 26 communicates 36 with the establishment's computer resource 30 to create a virtual ticket or otherwise provide information that permits the credit account to be opened within the establishment systems. Later, when the user/patron uses the credit account, the establishment computer resource 30 communicates information regarding purchases 38 back to the server 26, which facilitates payment of same via communications with a credit card processing center 40. Of course other means may be used. For example, in the case where a user has established an escrow account, the service may deduct funds from that account upon presentment of the charges by the establishment. Once payment has been effected, the server 26 returns payment information 42 to the establishment's computer resources 30. Alternatively, this information may be passed directly from the credit card processing center 40 to the establishment's computer resources 30.

Of course, many other architectures may be used to facilitate the processes described herein and the invention is not limited to the use of the architecture illustrated in FIG. 2. For example, some or all of the operations of the client 24 may be facilitated through the use of a mobile phone with a browser or dedicated application program. Such a scheme is especially useful inasmuch as it allows users to provision credit accounts without the need to access a personal computer and browser. Also, the client 24 may be resident at the establishment and may in fact be part of the computer resource 30. This way the establishment can allow patrons to use tabs, without the need to process individual credit card transactions and/or retain custody of credit cards of multiple patrons for extended periods. This reduces the possibility of theft or other misappropriation of patrons' credit/debit cards.

In any of the above-described scenarios, communications may be facilitated by wired (e.g., Ethernet, etc.) or wireless (e.g., WiFi, WiMAX, etc.) networks or combinations of the two. Where mobile phones or similar devices are used, GPRS/GSM or other mobile phone communication protocols may be used. SMS or similar text-based messaging systems may be used to transport information from mobile phones to/from the computer systems described herein. Likewise, telephone calls placed to the interactive service described above can be used to provision/activate/deactivate accounts.

The present invention thus provides patrons with the flexibility of using credit accounts instead of cash or other payment means at various establishments, without the risks associated with conventional tabs. For example, because a physical credit card need not be left with an establishment while the credit account is open, the risk of loss or compromise of that credit card is greatly reduced. Convenience is also enhanced because a patron need not take time to physically close out a tab and sign a receipt when he/she wishes to leave an establishment. That process can be effected via a mobile phone or other device or simply preconfigured at the time a user provisions the account. Gratuities can be automatically provided as well.

For the establishment, the convenience of offering patrons the ability to pay via credit account may enhance their business and may also reduce the time required for closing tabs and processing transactions. Bartenders or others are relieved of the burden of having to physically safeguard patrons' credit cards and the like. Also, the establishments are able to close out all open credit accounts on a same-day basis even if a patron departs the venue without closing his/her account.

An embodiment of the present invention may provide enhanced user interactivity and flexibility for certain types of venues. For example, where a restaurant or night club supports an on-line reservation system or is in need of one, the present invention may enable a user to select a preferred table within the venue and/or select from an extended list of preferences during the same session in which he requests provisioning of the venue-based credit account. For example, the user may be presented with an on-line menu from which he may preselect appetizers, drinks, or an entire meal.

Where “bottle service” is provided at a venue (i.e., where one or more bottles are sold by the venue to patrons for their personal consumption at the venue, usually at a table reserved for the patrons' party and served with mixers of the patrons' choice) still further user preferences may be preselected by the user. For example, the user may select the types and brands of beverages and mixers, the types and quantity of accompanying food, service and presentation details, etc.

Furthermore, the service may seamlessly integrate table reservation service and social networking services with provisioning of the venue-based credit account. As an example, a first user may set up a reservation and request provisioning of the venue-based credit account using the service, thereby creating an “event”. An option may be provided to the first user to forward the reservation information associated with the event to one or more other users. These other users may be “guests” or “invitees” of the first user, in which case only reservation information may be forwarded in the form of an invitation to the event. Alternately, one or more other users may be proposed by the first user as “co-hosts” from whom the first user expects contribution to the cost of the transactions. In the latter case, the service may provide means for each proposed “co-host” to accept or decline the invitation to contribute, and enable an accepting co-host to provide his/her payment guarantee means.

Forwarded reservation information can be contained in an email in its entirety or an email can direct the invitee to a web address displaying all the details of the reservation information. There the invitee can take actions necessary to confirm their attendance if required. Names of the user, invitees and co-hosts may be placed on the establishment's guest list.

Other social networking functions may be provided by the service as well. For example, the service enables a user to unobtrusively and conveniently “buy a drink” or “buy a round” for one or more other patrons at the venue. Other examples will be evident to those of skill in the art.

In an embodiment, the service may accept “contingent reservation” requests. Such requests may be convenient for a host user wishing, for example, to hold a reservation for a time period during which the host determines the availability of invitees or the willingness of proposed co-hosts to contribute to the transaction cost.

In yet a further embodiment, the service enables promotional, virtual coupons (or “e-coupons”) to be provided to the user. Such an e-coupon may be issued, for example, by a product manufacturer or distributor and enable the user to receive savings on the purchase of a product or beverages designated by the coupon. The e-coupon may be provided in a cooperative promotion with the venue. Alternatively, the venue need not be aware of the e-coupon, in which case the e-coupon benefit to the user would take the form, for example, of the e-coupon issuer contributing a designated amount toward the cost of a user's purchase.

Thus, methods and systems for preauthorizing spending on an existing credit account for transactions, such as purchases of food, beverages, and merchandise at designated venues prior to initiating such purchases have been described.

What is claimed is:

1. A method for a third party to preauthorize spending at a venue, said method comprising:
provisioning, on behalf of a user, a venue-based credit account for a spending transaction,
enabling said transaction only after at least one of the user and a user-designee authorizes the venue to activate the provisioned venue-based credit account, and the third party provides, on behalf of the user, a credit status of the user to the venue; and
deactivating the venue-based credit account only after a triggering event, said deactivating step comprising the third party financially settling the transaction on behalf of the user.

2. The method of claim 1, wherein the third party comprises a business enterprise operating at least one of a Web site and other equipment adapted to interact with the user, and to provision the venue-based credit account.

3. The method of claim 2, wherein the business enterprise operates at least one Internet web site hosted by at least one server.

4. The method of claim 3, wherein activating the venue-based credit account comprises creating a virtual ticket within a point of sale processing system associated with the venue.

5. The method of claim 3, wherein the triggering event comprises at least one of the user and the venue deactivating the venue-based credit account.

6. The method of claim 3, wherein the triggering event comprises expiration of a period of time.

7. The method of claim 3, wherein the third party receives user-payment-guarantee means from the user.

8. The method of claim 7, wherein the credit status of the user and the user-payment-guarantee means are identical.

9. The method of claim 3, wherein the third party receives a request from the user to provision the venue-based credit account while the user is located at the venue.

10. The method of claim 3, wherein the third party receives a request from the user to provision the venue-based credit account while the user is located away from the venue.

11. The method of claim 3, wherein the third party receives a request from the user through an interactive response system interface.

12. The method of claim 11 wherein the interactive response system is accessible to the user by telephone.

13. The method of claim 3, wherein the third party receives a request from the user via the Internet web site.

14. The method of claim 3, wherein a request of the user to provision a venue-based credit account comprises at least one user preference and the step of provisioning comprises informing the venue of the at least one user preference.

15. The method of claim 14, wherein the user preference comprises at least one of a gratuity, a method of calculating a gratuity amount, and acceptance of a gratuity policy set by the venue.

16. The method of claim 14, wherein the user preference comprises a payment guarantee means.

17. The method of claim 16, wherein the payment guarantee means comprises at least one of a cash prepayment, a bank account, a credit card account, a debit card account, and a web-based payment guarantee.

18. The method of claim 3, wherein a request of the user to provision a venue-based credit account comprises at least one user reservation request and the step of provisioning comprises informing the venue of the reservation request and receiving an indication from the venue when the reservation request is confirmed.

19. The method of claim 18, wherein the user reservation request comprises identifying a specific table at the venue.

20. The method of claim 18, wherein the user reservation request comprises a request for bottle service.

21. The method of claim 20, wherein the user reservation request comprises identifying at least one of a quantity, a type and a brand of a beverage.

22. The method of claim 18, wherein the request of the user further comprises identification of invitees, and the provisioning step comprises forwarding invitations to said invitees.

23. The method of claim 18, wherein the user reservation request is a contingent reservation request.

24. The method of claim 23, wherein the user reservation request further comprises identification of co-hosts and the provisioning step further comprises forwarding a request for contribution to each of said co-hosts.

25. The method of claim 24, wherein the provisioning step further comprises receiving at least one of an acceptance and a declination of said request for contribution.

26. The method of claim 25, wherein the acceptance comprises co-host payment guarantee means.

27. The method of claim 3, wherein the credit status of the user provided to the venue comprises a credit guarantee.

28. The method of claim 27, wherein the credit guarantee comprises at least one of a bank account, credit card account, debit card account, and a web-based credit guarantee.

29. The method of claim 27, wherein the credit status of the user further comprises a spending limit associated with the credit guarantee.

30. The method of claim 27, wherein the credit status of the user excludes personal financial information of the user.

31. The method of claim 3, wherein, at least one of the user and the user-designee authorize the venue to activate the provisioned venue-based credit account by presenting at least one of a password, said password having been provided by the third party to the user and to the venue, a bank card, and a biometric indicator.

32. The method of claim 31, wherein the biometric indicator comprises at least one of a photo-ID and a signature.

33. The method of claim 3, wherein the venue comprises at least one of a restaurant, a bar, a night club, and a retail store.

34. The method of claim 3, wherein a request by the user to provision a venue-based credit account comprises identifying the user-designee.

35. The method of claim 3, wherein the business enterprise contracts with a plurality of venues whereby each of said plurality of venues undertakes to accept payment by way of a venue-based credit account.

36. The method of claim 1, wherein financially settling the transaction comprises providing a payment processor with transaction clearing information, said transaction clearing information comprising financial information of the user and merchant account information of the venue.

37. The method of claim 1, further comprising:
receiving by the third party an authorization to furnish the user with a virtual coupon; and
furnishing the user with a virtual coupon.

38. The method of claim 37, wherein the authorization is provided by at least one of a product manufacturer, a product distributor, and a merchant.

39. A system for a third party to preauthorize spending at a venue, said system comprising at least one server operated by the third party and adapted to:
communicate with the venue and a user;
provision, on behalf of the user, a venue-based credit account for a spending transaction
enable said transaction only after at least one of the user and a user-designee authorizes the venue to activate the provisioned venue-based credit account, by providing, on behalf of the user, a credit status of the user to the venue; and
deactivate the venue-based credit account only after a triggering event by financially settling the transaction on behalf of the user.

40. The system of claim 39, wherein the third party comprises a business enterprise operating at least one of a Web site and other equipment adapted to interact with the user, and to provision the venue-based credit account.

41. The system of claim 40, wherein the business enterprise operates at least one Internet web site hosted by the server.

42. The system of claim 41, wherein the system is further adapted to activate the venue-based credit account by creating a virtual ticket within a point of sale processing system associated with the venue.

43. The system of claim 41, wherein the triggering event comprises at least one of the user and the venue deactivating the venue-based credit account.

44. The system of claim 41, wherein the triggering event comprises expiration of a period of time.

45. The system of claim 41, wherein the third party receives user-payment-guarantee means from the user.

46. The system of claim 45, wherein the credit status of the user and the user-payment-guarantee means are identical.

47. The system of claim 41, wherein the third party receives a request from the user to provision the venue-based credit account while the user is located at the venue.

48. The system of claim 41, wherein the third party receives a request from the user to provision the venue-based credit account while the user is located away from the venue.

49. The system of claim 41, wherein the third party receives a request from the user through an interactive response system interface.

50. The system of claim 49 wherein the interactive response system is accessible to the user by telephone.

51. The system of claim 41, wherein the third party receives a request from the user via the Internet web site.

52. The system of claim 41, wherein a request of the user to provision a venue-based credit account comprises at least one user preference and the step of provisioning comprises informing the venue of the at least one user preference.

53. The system of claim 52, wherein the user preference comprises at least one of a gratuity, a method of calculating a gratuity amount, and acceptance of a gratuity policy set by the venue.

54. The system of claim 52, wherein the user preference comprises a payment guarantee means.

55. The system of claim 54, wherein the payment guarantee means comprises at least one of a cash prepayment, a bank account, a credit card account, a debit card account, and a web-based payment guarantee.

56. The system of claim 41, wherein a request of the user to provision a venue-based credit account comprises at least one user reservation request and the step of provisioning comprises informing the venue of the reservation request and receiving an indication from the venue when the reservation request is confirmed.

57. The system of claim 56, wherein the user reservation request comprises identifying a specific table at the venue.

58. The system of claim 56, wherein the user reservation request comprises a request for bottle service.

59. The system of claim 58, wherein the user reservation request comprises identifying at least one of a quantity, a type and a brand of a beverage.

60. The system of claim 56, wherein the request of the user further comprises identification of invitees, and the provisioning step comprises forwarding invitations to said invitees.

61. The system of claim 56, wherein the user reservation request is a contingent reservation request.

62. The system of claim 61, wherein the user reservation request further comprises identification of co-hosts and the provisioning step further comprises forwarding a request for contribution to each of said co-hosts.

63. The system of claim 62, wherein the provisioning step further comprises receiving at least one of an acceptance and a declination of said request for contribution.

64. The system of claim 63, wherein the acceptance comprises co-host payment guarantee means.

65. The system of claim 41, wherein the credit status of the user provided to the venue comprises a credit guarantee.

66. The system of claim 65, wherein the credit guarantee comprises at least one of a bank account, a credit card account, a debit card account, and a web-based credit guarantee.

67. The system of claim 65, wherein the credit status of the user further comprises a spending limit associated with the credit guarantee.

68. The system of claim 65, wherein the credit status of the user excludes personal financial information of the user.

69. The system of claim 41, wherein, at least one of the user and the user-designee authorize the venue to activate the provisioned venue-based credit account by presenting at least one of a password, said password having been provided by the third party to the user and to the venue, a bank card, and a biometric indicator.

70. The system of claim 69, wherein the biometric indicator comprises at least one of a photo-ID and a signature.

71. The system of claim 41, wherein the venue comprises at least one of a restaurant, a bar, a night club, and a retail store.

72. The system of claim 41, wherein a request by the user to provision a venue-based credit account comprises identifying the user-designee.

73. The system of claim 41, wherein the business enterprise contracts with a plurality of venues whereby each of said plurality of venues undertakes to accept payment by way of a venue-based credit account.

74. The system of claim 39, wherein financially settling the transaction comprises providing a payment processor with transaction clearing information, said transaction clearing information comprising financial information of the user and merchant account information of the venue.

75. The system of claim 39, wherein the system is further adapted to:
receive an authorization to furnish the user with a virtual coupon; and
furnish the user with a virtual coupon.

76. The system of claim 75, wherein the authorization is provided by at least one of a product manufacturer, a product distributor, and a merchant.
